(19) United States
(12) Patent Application Publication
(10) Pub. No.: US 2024/0255974 A1
(43) Pub. Date: Aug. 1, 2024

(54) Automatic Gas Valve with Gas Pressure Regulator Poppet Lockout

(71) Applicants: Zachary Stephan Sandstrom, Itasca, IL (US); Brandon Heath Flanigan, Itasca, IL (US); Luke Nigliazzo, Itasca, IL (US); James Chopin, Itasca, IL (US)

(72) Inventors: Zachary Stephan Sandstrom, Itasca, IL (US); Brandon Heath Flanigan, Itasca, IL (US); Luke Nigliazzo, Itasca, IL (US); James Chopin, Itasca, IL (US)

(21) Appl. No.: 18/421,526

(22) Filed: Jan. 24, 2024

Related U.S. Application Data
(60) Provisional application No. 63/440,819, filed on Jan. 24, 2023.

(51) Int. Cl. G05D 16/16

(52) U.S. Cl. CPC G05D 16/163

(57) ABSTRACT

A housing with an inlet and an outlet has a port therein. A gas pressure regulator and a solenoid actuator act on a common seal so as to provide a redundant on/off capability for many gas appliances or other uses, preferably with a poppet sealing at the port. For at least some embodiments, a plunger located is upstream of the port and can selectively contact the plunger so as to push the plunger against the port in the off configuration. When in an on configuration, the plunger can move away from the port permitting the poppet to be directed by the gas regulator between an open and a closed configuration depending on the pressure of gas at the inlet relative to a predetermined pressure setting of the gas regulator.

### CLAIM OF PRIORITY

The present invention claims the benefit of U.S. Provisional Application No. 63/440,819 filed Jan. 24, 2023 which is incorporated herein by reference in its entirety.

### Field of the Invention

The present invention relates to gas pressure regulators often utilized with gas appliances and more particularly to a gas pressure regulator having an ability to provide a gas tight seal and more particularly a gas pressure regulator having an integral redundant sealing mechanism utilizing the valve set and poppet of the gas pressure regulator.

### BACKGROUND OF THE INVENTION

Gas pressure regulators have been manufactured by the applicant for years. These designs permit flow of gas at a particular pressure as set by the gas pressure regulator to therefore regulate the gas at a particular pressure as it proceeds from the inlet to the outlet of the regulator.

Many appliance manufacturers require a redundant seal to be present in a gas appliance so that if the gas regulator were to fail, such a failure would not result in a situation which could otherwise permit gas to be discharged through ports, or other locations, potentially into the living space of a user in an unwanted fashion. While solenoid gas open or shutoff valves have typically been installed downstream of gas pressure regulators, in such appliances there often remain potential leak points between a gas pressure regulator body and the body of the solenoid gas valve which are often spaced apart by piping, fittings, connections, etc.

Solenoid gas valves normally have a plunger which is normally biased shut or closed when de-energized against a valve seat. Upon energizing the solenoid, the plunger moves relative to an orifice (the valve seat) to thereby permit flow from inlet to the outlet of the valve. When the solenoid is de-energized the solenoid valve normally is in the shut configuration of an actuary a spring bias against the plunger thereby contacting the valve seat against the orifice.

Improvements such as applicant's U.S. Pat. No. 6,789,572, and others, have provided a compact valve/gas regulator combinations, but further improvements are believed to be possible, at least for some applications.

### SUMMARY OF THE INVENTION

It is an object of many embodiments of the present invention to provide a single housing supporting a gas pressure regulator and a solenoid actuator to provide a redundant seal.

It is an object of many embodiments of the present invention to provide an improved gas pressure regulator having an integral solenoid valve.

It is another object of many embodiments of the present invention to provide a gas pressure regulator having a gas flow path through a regulated port opening which is collinearly disposed with a solenoid actuator which acts on the regulator poppet to provide a redundant seal such as may be used in various gas appliances.

It is another object of many embodiments of the present invention to provide a housing between an inlet and an outlet with a gas pressure regulator having a poppet which can be closed with a solenoid actuator.

Accordingly, in accordance with a presently preferred embodiment of the present invention, a housing has an inlet and an outlet with a gas pressure regulator there between. Specifically, a poppet is moveable relative to an orifice on the inlet side of the orifice. A spring biased diaphragm normally displaces the poppet apart from the orifice to permit gas flow until the pressure on the inlet side exceeds a predetermined amount, and then bias is overcome to have the poppet seal off the opening. This is a gas pressure regulator. If the gas pressure on the inlet side is too high, then the spring force is overcome and the poppet seals shut the orifice and the flow of gas. If the gas pressure is not too high and does not exceed the amount of pressure permitted by the regulator, then the poppet is held spaced apart from the orifice allowing for gas flow through the orifice and out the outlet. That type structure has been utilized by gas appliance for decades.

What is new for many embodiments is that the housing supporting the inlet and the outlet also has a solenoid actuator which selectively acts on the poppet. When in an energized state the actuator plunger is pulled away from the poppet thereby allowing the poppet to perform its normal regulating function. However, upon power being secured to the solenoid actuator, then the bias of the spring on the actuator plunger moves the actuator plunger against the poppet and shuts the poppet against the orifice to provide a redundant seal so that no flow flows through the gas pressure regulator in the absence of the solenoid being activated. The shutoff acts at the pressure regulator and not downstream like prior art designs.

An improvement of this current design permits significant less amount of equipment and machining as compared to prior art designs. Specifically, for at least some embodiments, the solenoid actuator may be arranged so that the actuator plunger is colinearly disposed with the piston supporting the poppet of the gas pressure regulator (and coaxially disposed relative to the orifice) for at least some preferred embodiments.

The servo actuator preferably selectively acts on the poppet to seal the poppet against the orifice when the valve is “off” for many embodiments, while not contacting the poppet when the solenoid valve is “on.”

### BRIEF DESCRIPTION OF THE DRAWINGS

The particular features and advantages of the inventions with other objects will become apparent from the following description taken in connection with the accompanying drawings in which:

FIG. 1 is a cutaway view of a presently preferred embodiment of the present invention;

FIG. 2 is a schematic of detail B of FIG. 1 in a shut or off configuration; and

FIG. 3 is a schematic view of detail B in an “open” configuration.

### DETAILED DESCRIPTION OF THE PREFERRED EMBODIMENT

Gas valve 10 is a dual function valve with (a) a gas pressure regulator 20 and (b) a solenoid actuator 22 located in detail A. Valve 10 has an inlet 12 and an outlet 14 preferably machined into a housing 16. A poppet 18 is preferably moveable relative to an orifice 24 so as to selectively permit the flow of gas between the inlet 12 and the outlet 14. The gas pressure regulator 20 can operate similar to many other gas pressure regulators available in the market. Specifically, a diaphragm 26 connects is spring biased such as by one or more springs 28, 30.

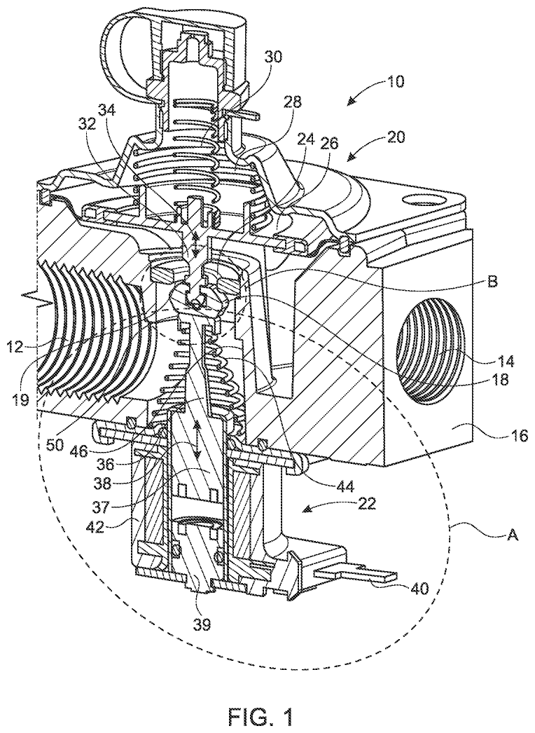

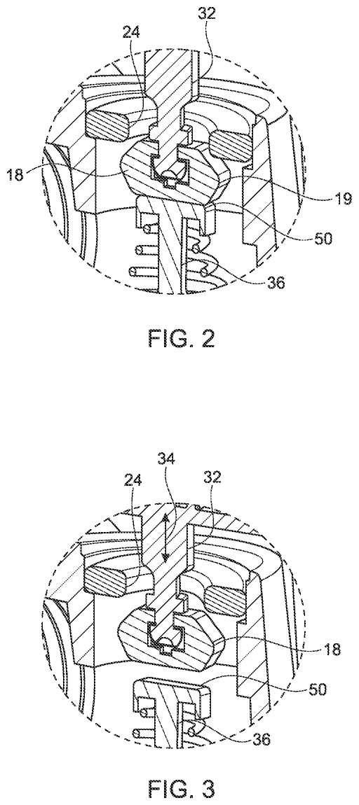

The gas pressure regulator may use a piston 32 extending from the diaphragm 26 to support the poppet 18 preferably in an initially open configuration regulative to the orifice 24 with the gas pressure regulator 20 set to a predetermined pressure such as those traditionally utilized in gas appliances. Should the pressure at the inlet 12 exceed the designed pressure, then the poppet 18 seals against the orifice 24 to provide a seal. When the pressure at inlet 12 is less than the preset pressure of the regulator 20 then the poppet moves to the open configuration such as shown in FIG. 1. One of ordinary skill will understand that the poppet 18 moves along axis 34 between the open and closed configuration. Other gas pressure regulators (GPRs) 20 may operate differently but otherwise move a poppet 18 relative to orifice 24 to provide a valve seat 19 in an over pressure configuration and spacing the poppet 18 from the opening or orifice 20 in an open configuration therefore permitting the flow of gas between the inlet 12 and the outlet 14 when below the predetermined pressure.

What differentiates many embodiments of valve 10 from prior art designs is that a solenoid assembly 22 has a plunger 36 which moves along axis 38 between an open position, such as the one illustrated in FIG. 3, with sufficient power being provided at power connection 40, or other appropriate connections to energize solenoid 42 to initially overcome the bias of spring 44 so that the plunger 36 can initially be moved to be spaced apart from the poppet 18.

The pressure regulator 20 is allowed to function in its normal configuration in this configuration. However, upon transitioning the solenoid assembly 22 to an off configuration normally by securing power such as at the power connection 40 to the solenoid 42, the plunger 36 is forced by bias of the spring 44 against the poppet 18 to have it seat against the valve seat 19 to secure gas flow through the orifice 24.

Note that for the preferred embodiment, the axis 38 is the axis of the plunger 36 as well as the solenoid assembly 22 for many embodiments. Solenoid axis 38 may be colinear with the gas pressure regulator axis 34 which moves the poppet 18 through the piston 32. Other embodiments may not require these two axes 34,38 to be colinear, possibly perpendicular to one axis of the inlet and/or outlet. Nevertheless, the solenoid assembly 22 selectively acts on the poppet 18 to seal at the valve seat 19 with the poppet 18 when the valve 10 is turned off and allow the plunger 36 to disengage the poppet 18 when open with the gas pressure regulator 20 performing is regulating function when the solenoid assembly 22 is energized and/or open. Such an action can create a redundant gas seal when the solenoid is in the off position which may be required by at least some gas appliance manufacturers.

Solenoid assembly 22 may have the solenoid 42 located at least external to the housing 16 and extending through a bore 46 allowing the plunger 36 to extend through the bore 46 with the bore 46 being coaxially disposed relative to the opening 24 for many embodiments. The diaphragm 26 and springs 28,30,44 may also be coaxially disposed relative to the opening 24 and the bore 46 for many embodiments. Other embodiments may not provide this coaxial/colinear arrangement.

The plunger 36 acting as a solenoid armature may be pressed against the poppet 18 with the force from the spring 44 when in an off configuration. When the solenoid 42 is activated, the armature or plunger 36 is retracted away from the poppet 18 to allow for gas flow as permitted by the regulator 20. The on/off function of the solenoid actuator 22 occurs at the opening 24 and not downstream as occurs with prior art designs using separate valves from the gas regulator 20.

Numerous alterations of the structure herein disclosed will present themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having set forth the nature of the invention, what is claimed herein is:

1. A gas valve comprising:
a housing having a gas flow path and a common seal of a gas pressure regulator and a solenoid actuator located therein, when actuated;
said gas pressure regulator having an open and closed configuration wherein until reaching a predetermined pressure, the gas pressure regulator permits gas flow through the housing, but upon reaching the predetermined pressure, the gas pressure regulator prevents gas flow through the gas flow path at the common seal; and
said solenoid actuator has an on configuration permitting gas flow through gas flow path and an off configuration preventing gas flow through the gas flow path at the common seal;
wherein when the solenoid valve is in the on configuration, the gas pressure regulator operates between the open and closed configuration depending upon gas pressure.

2. The gas valve of claim 1 further comprising a poppet upstream in the gas flow path of a port, and said poppet sealing against the port provides the common seal.

3. The gas valve of claim 2 wherein when the gas pressure regulator has a piston extending through the port and connecting to the poppet.

4. The gas valve of claim 3 wherein the solenoid actuator has a plunger which is colinearly disposed with the piston.

5. The gas valve of claim 4 wherein the housing has an inlet and an outlet and an axis extending through the plunger is perpendicularly disposed relative to one of the inlet and outlet.

6. The gas valve of claim 4 wherein a solenoid of the solenoid valve is disposed externally of the housing.

7. The gas valve of claim 2 wherein the gas pressure regulator has a spring biasing the poppet away from the port.

8. The gas valve of claim 3 wherein the gas pressure regulator has a spring biasing the poppet away from the port, and the solenoid actuator has a spring biasing the plunger to seal the poppet against the port in the off configuration, wherein upon energizing the solenoid, the plunger is moved away from the port permitting the gas pressure regulator to regulate pressure.

9. A combination solenoid and regulator valve comprising:
a housing having and inlet and an outlet;
a gas pressure regulator having a poppet disposed on an inlet side of a port moveable from an open and a closed configuration, wherein until reaching a predetermined pressure, the gas pressure regulator permits gas flow through the housing, but upon reaching the predetermined pressure, the gas pressure regulator prevents gas flow through the gas flow path with the poppet sealed against the port; and
a solenoid actuator having an off configuration sealing the poppet against the port and an on configuration permitting the gas pressure regulator to operate between the open and closed configuration depending upon gas pressure.

10. The combination solenoid and regulator valve of claim 9 wherein the gas pressure regulator has a piston and the solenoid actuator has a plunger.

11. The combination solenoid and regulator valve of claim 10 wherein the piston and plunger are colinear.

12. The combination solenoid and regulator valve of claim 11 wherein an axis of the piston and plunger are perpendicular to an axis through at least one of the inlet and outlet.

13. The combination solenoid and regulator valve of claim 10 wherein the piston extends through the port and connects to the poppet.

14. The combination solenoid and regulator valve of claim 10 wherein the solenoid actuator has a solenoid connected to the housing.

15. The combination solenoid and regulator valve of claim 10 wherein the gas pressure regulator has a spring biasing the poppet away from the port.

16. The combination solenoid and regulator valve of claim 15 wherein the solenoid actuator has a spring biasing the plunger to seal the poppet against the port in the off configuration, wherein upon energizing the solenoid, the plunger is moved away from the port permitting the gas pressure regulator to regulate pressure.
